(19) United States
(12) Patent Application Publication
(10) Pub. No.: US 2026/0340141 A1
(43) Pub. Date: Oct. 29, 2026

(54) AI-DRIVEN PREDICTION OF INVALID SECURITY DEFECTS

(71) Applicant: SAP SE, Walldorf (DE)

(72) Inventors: Yang Xu, Xi'An (CN); Jinming Lv, Xi'An (CN); Hang Nai, Xi'An (CN); Yong Li, Xi'An (CN); Qiao-luan Xie, Xi'An (CN)

(21) Appl. No.: 19/189,807

(22) Filed: Apr. 25, 2025

(51) Int. Cl. G06F 21/57

(52) U.S. Cl. CPC G06F 21/577; G06F 2221/033

(57) ABSTRACT

Embodiments of the present disclosure include techniques for AI-driven prediction of invalid security defects. In one embodiment, historical security defects are received and then applied to a trained large language embedding model to generate embedding vectors for the historical security defects. The embedding vectors are passed through one or more neural network layers to generate model invalidity predictions. A new security defect is received and applied to the trained large language embedding model, and the embedding vector of the new security defect is used to search for similar security defects. The new security defect is classified as valid or invalid based at least in part on a model invalidity prediction of the new security defect and the similar security defects.

### BACKGROUND

The present disclosure relates generally to computer software systems, and in particular, to systems and methods for AI-driven prediction of invalid security defects.

A security defect is a software flaw or vulnerability that attackers can exploit, potentially compromising the system's security. Databases for cloud computing platforms must be highly secure and require frequent static security scans and constant updates. For robustness, security scans may be overinclusive and result in many false positives. In other words, although a security system may detect many defects, some of the defects may be invalid, and thus, are a waste of resources to address. However, because any one defect may prove to be critical, all defects that are detected must be evaluated and tested within the system to ensure that any security flaw is resolved before it is exploited. Because there may be thousands of potential defects detected with each scan, it is infeasible for a human to manually inspect all defects to assess whether they are truly valid or are merely false positives.

Therefore, contemporary systems suffer from the technical challenge of accurately and precisely differentiating between valid and invalid security defects in a robust and efficient manner. The following disclosure provides various solutions to technical problems associated with such systems.

### BRIEF DESCRIPTION OF THE DRAWINGS

FIG. 1 illustrates a system for AI-driven prediction of invalid security defects according to an embodiment.

FIG. 2 illustrates a computer-implemented method for predicting invalid security defects according to an embodiment.

FIG. 3A illustrates a system for training an AI for predicting invalid security defects according to an embodiment.

FIG. 3B illustrates a computer-implemented method for training an AI for predicting invalid security defects according to an embodiment.

FIG. 3C illustrates an example of a security defect log expressed as natural language in a first training dataset according to an embodiment.

FIG. 3D illustrates an example of a prompt in a second training dataset according to an embodiment.

FIG. 4A illustrates an ensemble model according to an embodiment.

FIG. 4B illustrates examples of threshold parameters according to an embodiment.

FIG. 4C illustrates an example of measured performance according to an embodiment.

FIG. 5 illustrates hardware of a special purpose computing system configured according to the above disclosure.

### DETAILED DESCRIPTION

Described herein are techniques for AI-driven prediction of invalid security defects. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein.

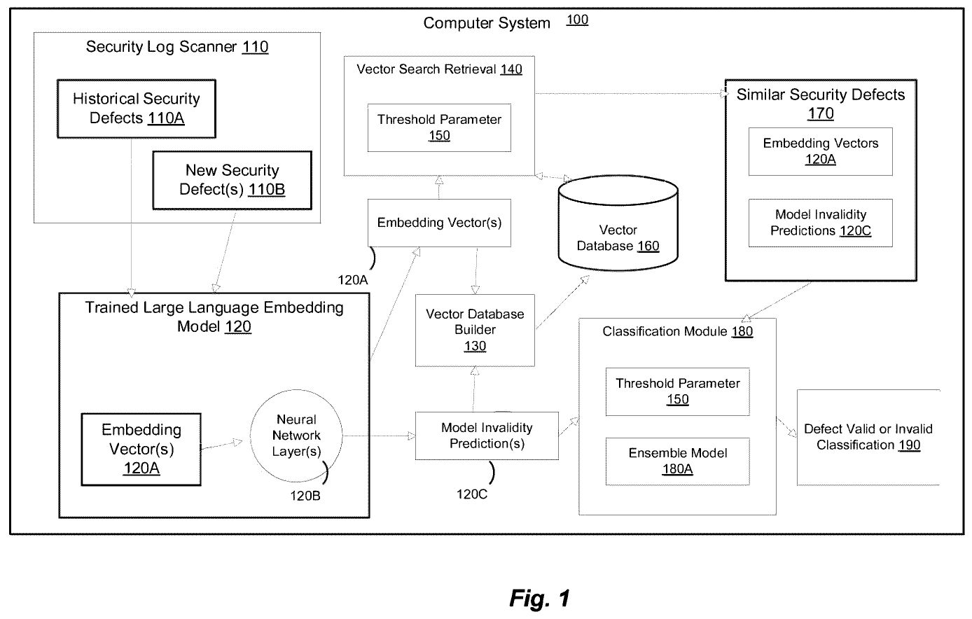

FIG. 1 illustrates a system for AI-driven prediction of invalid security defects according to an embodiment. Features and advantages of the present disclosure include detecting invalid (false positive) security defects amongst a voluminous stream of security logs obtained in a dynamic computer system. Computer system 100 may include, for example, one or more computers comprising one or more processors and a computer readable medium (memory) for executing software to perform the techniques described herein. Here, embodiments of the present disclosure include techniques for predicting invalid security defects using an artificial intelligence (AI) and for techniques for training the AI, for example. In embodiments, computer system 100, as shown in FIG. 1, may correspond to an AI system as executed during inference.

The computer system 100 may perform functions for users as part of a cloud computing platform. For example, the computer system 100 may perform functions relating to multi-modal data management and analytics. As such, the computer system 100 may implement techniques for maintaining system security within the cloud computing platform by detecting security defects and addressing the security defects that are most likely to be valid, especially with respect to major security defects. For example, a major security defect may include any security defect that affects a key performance indicator of the computer system 100 and its ability to properly perform its cloud computing functions. The computer system 100 comprises a security log scanner 110, a trained large language embedding model 120, a vector database builder 130, a vector database 160, vector search retrieval 140, and a classification module 180.

The security log scanner 110 may obtain security logs, which may comprise data messages that record information about actions occurring within the computer system 100, and for the purpose of detecting security defects. The security defects may include actions signifying a security vulnerability, such as anomalous events occurring in the computer system 100. For example, anomalous events may include buffer overflows, unusual network traffic, atypical sets of executions, and the like. The security log scanner 110 may detect security defects amongst the security logs, some of which may be valid or invalid. The security defects may be configured as data messages comprising unique identifiers, headers, and descriptions of events and event sequences as its attributes. For example, the attributes may include descriptions of relevant file paths, functions, keys, number of occurrences, last date of detection, event attributes, and any other data element relating to the time, location, and nature of the security defect, or some combination thereof.

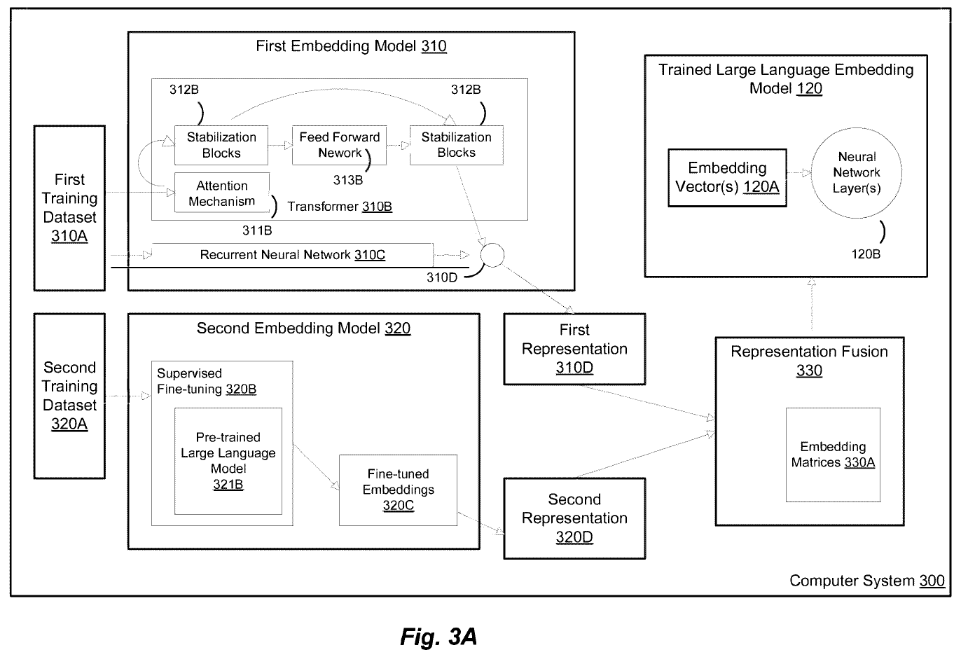

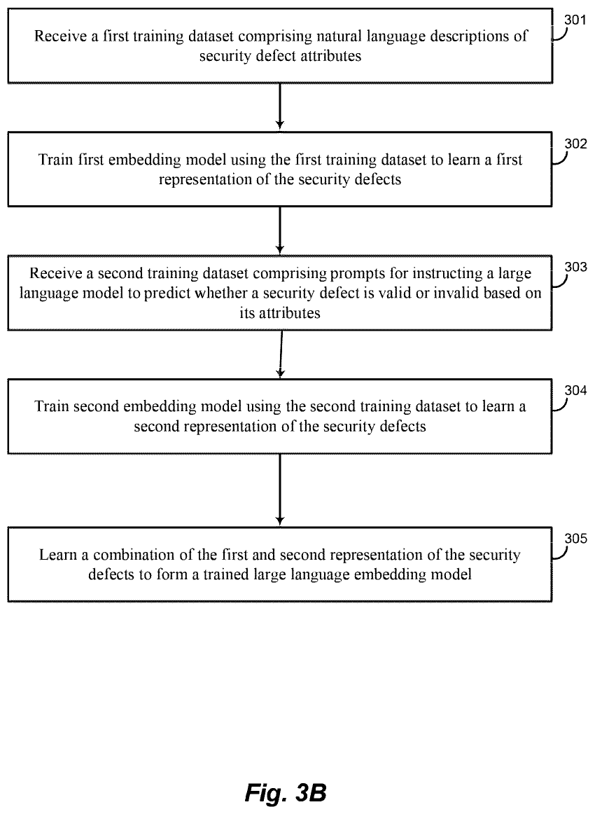

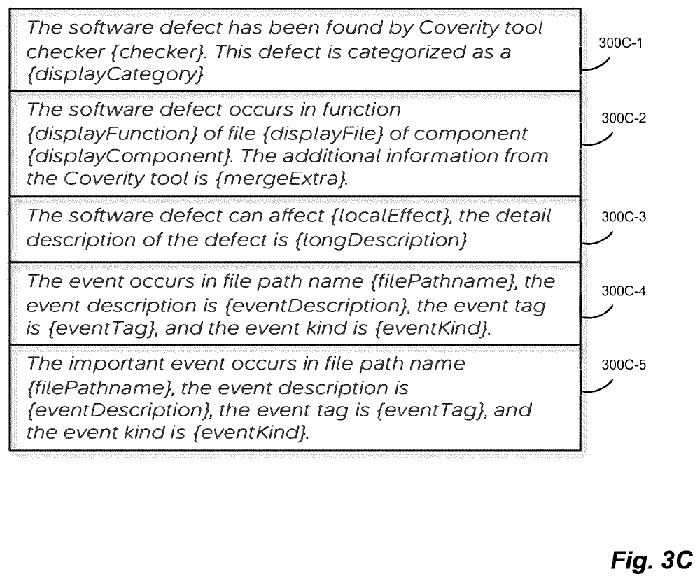

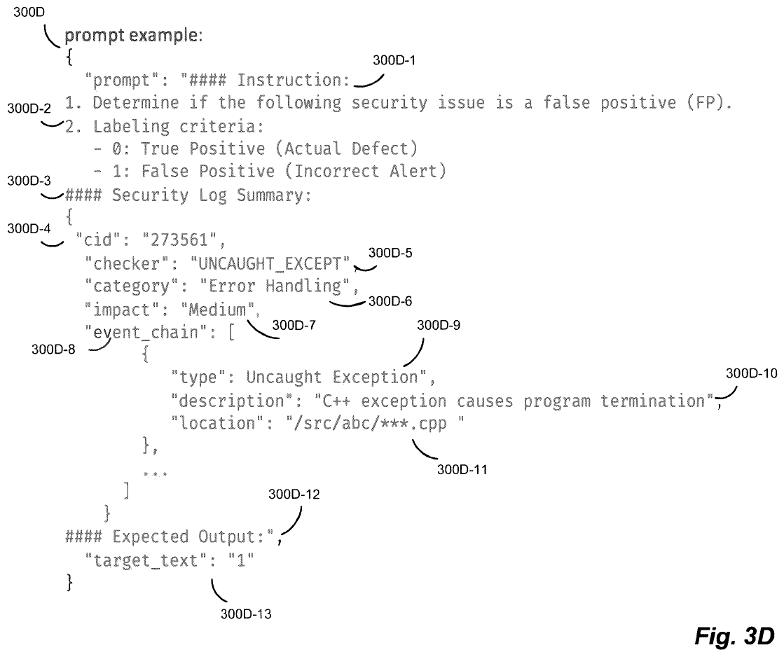

The security log scanner 110 may detect historical security defects 110A and new security defects 110B. The historical security defects 110A may comprise a batch of security defects collected over a period. The new security defects 110B may comprise security defects that are collected in real-time, near real-time, or within a relatively short period of time as compared to the historical security defects 110A. In one embodiment, new security defects 110B collected over time can be stored for future use as historical security defects 110A. To build the vector database, historical security defects 110A are initially processed and passed to the trained large language embedding model 120 to generate embedding vectors 120A. The trained large language embedding model 120 is configured to receive security defects and generate embedding vectors 120A for each security defect and its corresponding security log data. In embodiments, the embedding vectors 120A are configured as numerical representations of the semantic and contextual information that may be hidden in security defect data. For example, the dimensions of an embedding vector may implicitly represent the latent variables relevant for predicting whether a defect is valid or invalid. As such, embedding vectors 120A that are close to each other in the embedding space may generally have similar characteristics and features, which may not always be explicitly expressed in raw data and instead may need to be learned. To learn how to generate the embedding vectors 120A from security log data, the trained large language embedding model 120 is trained through the training methods described with respect to FIGS. 3A, 3B, 3C, and 3D, which are described in greater detail further below. Additionally, the trained large language embedding model 120 may be configured to generate a model invalidity prediction 120C assessing whether the security defect is likely to be valid or invalid (i.e., a false positive). A “model invalidity prediction” refers to the direct predictions of the trained large language embedding model 120. For example, a model invalidity prediction 120C may be configured as a binary classification task, where 1=True for invalid, and 0=False (valid), or vice versa. The model invalidity prediction 120C for a security defect can be determined directly from its corresponding embedding vector by passing the embedding vector through one or more neural network layers 120B. In one embodiment, the neural network layer may be a single activation layer, such as a SoftMax or sigmoid activation function. For example, passing an embedding vector through the activation function may generate an output vector containing the likelihood that it belongs to the “valid” class and the likelihood that it belongs to the “invalid” class. The higher probability class (e.g., greater than 50%) is selected as the model invalidity prediction 120C. In one embodiment, the neural network layers 120B may include multiple hidden layers prior to the activation layer to form a deep neural network, where the weights of the hidden layers are updated through back propagation.

The computer system 100 applies historical security defects 110A to the trained large language embedding model 120 to generate the embedding vectors 120A and model invalidity prediction 120Cs for each historical security defect. The vector database builder 130 compiles the embedding vectors 120A, stores the embedding vectors 120A in the vector database, and associates each embedding vector with its corresponding model invalidity prediction 120C. Data in the vector database can later be used to inform classifications of new security defects 110B as valid or invalid. When a new security defect 110B is received by computer system 100, it can be applied to the trained large language embedding model 120 to generate its embedding vector 120A and model invalidity prediction 120C. The model invalidity prediction 120C of the new security defect 110B forms one aspect of how the new security defect 110B is ultimately classified as valid or invalid. The other aspect involves using the embedding vector of the new security defect 110B to search for similar security defects 170. Through the use of ensemble learning, the similar security defects 170 can be used to assess or reassess model invalidity predictions 120C. The computer system 100 can use vector search retrieval 140 to search the vector database 160 for the similar security defects 170. For example, vector search retrieval 140 may include the functions of obtaining the embedding vector for the new security defect 110B and calculating a similarity metric (e.g., cosine similarity or Euclidean distance) against each embedding vector stored in the vector database 160. The similar security defects 170 may be the security defects where the similarity metric exceeds a threshold parameter 150, which may include a similarity score that must be met or exceeded to qualify as sufficiently similar. For example, using cosine similarity, the threshold parameter 150 may require that the similarity be greater than 0.5, on a −1 to 1 scale, where 0 and below signifies highly dissimilar, and 1 signifies highly similar.

Furthermore, in some embodiments, the threshold parameter 150 may comprise an additional component corresponding to an invalid defects rate (IDR). In embodiments, the classification module 180 is configured to re-evaluate the model invalidity predictions 120C when there is a significant portion of invalid defects. For example, in one embodiment, the IDR is calculated as a ratio of invalid to valid defects, where exceeding an acceptable proportion of invalid defects triggers the computer system 100 to reevaluate the model invalidity prediction 120C of new security defects 110B. In one embodiment, the IDR is evaluated for each new security defect 110B based on the model invalidity predictions 120C of its similar security defects 170. For example, after the similar security defects 170 are retrieved, the classification module 180 determines what percentage of the similar security defects 170 have a model invalidity prediction 120C of “invalid.” If the percentage does not exceed a predetermined threshold, the classification module 180 accepts the model invalidity prediction of the new security defect 110B as its invalid/valid classification. Otherwise, the classification module 180 may use an ensemble model 180 to determine whether the new defect is valid or invalid.

When the classification module 180 determines that the threshold parameter is exceeded, the classification module 180 may apply the model invalidity prediction for the new security defect 110B and the similar security defects 170 to the ensemble model 180. In embodiments, the ensemble model 180 comprises a set of classifiers that can vote against the model invalidity prediction of the new security defect 110B, for example, by a simple majority vote, weighted vote, or other voting scheme. As one example, the ensemble model 180 may comprise two classifiers in addition to the model invalidity prediction, and the model invalidity prediction may be overridden when the two classifiers each register a vote of “valid” for the new security defect 110B against the model invalidity prediction's single vote of “invalid.” In some embodiments, the classifiers may include one or more lazy learner algorithms (e.g., k-nearest neighbors, lazy naïve bayes, and/or local regression). The similar security defects 170 can be used as the training dataset for identifying the k-nearest neighbors of the new security defect 110B. Amongst the embedding vectors 120A of the similar security defects 170, distances from the embedding vector of the new security defect 110B can be calculated, and the model invalidity predictions 120C associated with the k-nearest embedding vectors 120A can be used in a majority voting scheme. For example, where k is 5, the lazy learner will determine the new security defect 110B to be invalid if 3 out of the 5 nearest security defects have a model invalidity prediction of “invalid.” In some embodiments, the classifiers of the ensemble model 180 may include one or more probabilistic classifiers (e.g., naïve bayes classifier, logistic regression, and/or probabilistic random forest). For example, the similar security defects 170 can be used as the training dataset for learning which dimensions of the embedding vectors 120A are most predictive of an invalid label based on conditional probability. The probabilistic classifier may then predict the valid or invalid label of the new security defect 110B based on the values of the most predictive variables. In embodiments, the ensemble model 180 may comprise any number of lazy learners, probabilistic classifiers, or combinations thereof. Upon receiving the classifications from the ensemble model 180, the classification module 180 may compare the ensemble classifications to the model invalidity prediction of the new security defect 110B and make a final determination 190 of valid or invalid (e.g., by majority vote as described above). In one embodiment, the new security defect 110B and its embedding vector, model invalidity prediction, and/or final valid or invalid classification 190 may be stored in the database 160.

As previously mentioned, whether the classification module 180 uses the ensemble model 180 to reevaluate the model invalidity predictions 120C is dependent on the threshold parameter 150, which may be adjusted as needed. For example, when there is a large quantity of detected defects received in a short period, the invalidity defect rate (IDR) component of the threshold parameter can be set higher to identify as many invalid defects as possible. In another example, when the AI begins to overshoot and makes too many invalid predictions, the vector similarity component of the threshold parameter can be set lower so that a wider set of historical security defects 110A are used to reevaluate the model invalidity predictions 120C and improve accuracy. In embodiments, the threshold parameter can be adjusted real-time without interrupting the operations of the computer system 100. This allows the computer system 100 to adapt to new data features quickly and prioritize resources, which may be limited. Embodiments of the present disclosure overcome the technical challenges associated with detecting valid security defects in a dynamic system. Additionally, embodiments of the present disclosure overcome the technical challenges of deploying an AI that can identify invalid security defects with sufficient accuracy, precision, and recall. For example, to be deployable, the AI should be able to target several minor security defects that are invalid, without inadvertently targeting major security defects that are valid. Further examples for overcoming the technical challenges are described in more detail below.

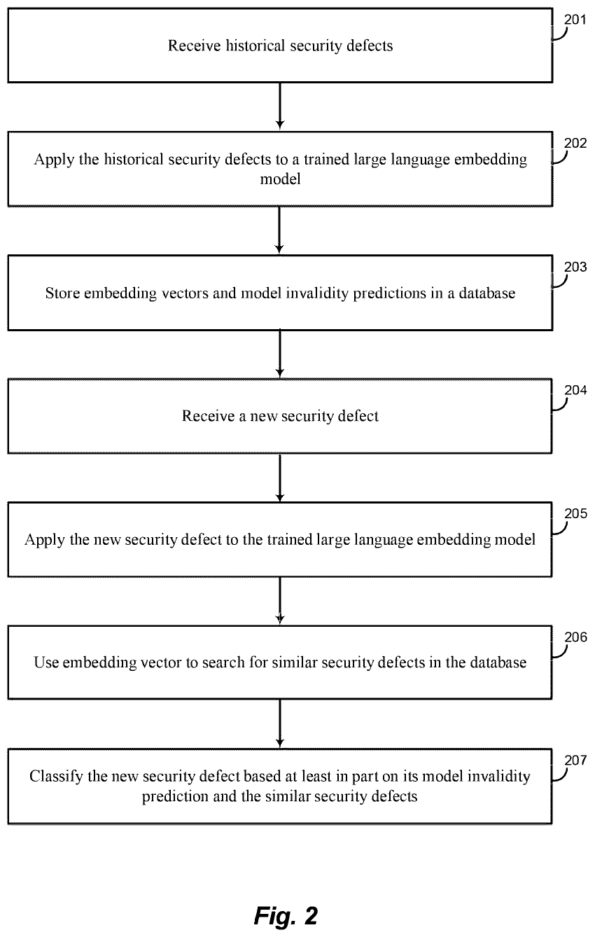

FIG. 2 illustrates a computer-implemented method for predicting invalid security defects according to an embodiment. In embodiments, the method may be performed by computer system 100. At 201, the computer system 100 receives historical security defects 110A. At 202, the computer system 100 applies the historical security defects 110A to a trained large language embedding model 120. The trained large language embedding model 120 generates embedding vectors 120A of the historical security defects 110A and passes the embedding vector through one or more neural network layers 120B to generate model invalidity predictions for each historical security defect. At 203, the computer system 100 stores the embedding vectors 120A and the model invalidity predictions in a database 160, which may be a vector database. At 204, the computer system 100 receives a new security defect 110B. At 205, the computer system 100 applies the new security defect 110B to the trained large language embedding model 120. The trained large language embedding model 120 generates the embedding vector of the new security defect 110B and passes the embedding vector through one or more neural networks to produce a model invalidity prediction for the new security defect 110B. At 206, the computer system 100 uses the embedding vector to search for similar security defects 170 in the database. In one embodiment, the search is performed using a vector similarity threshold as a threshold parameter 150. At 207, the computer system 100 classifies the new security defect 110B based at least in part on its model invalidity prediction and the similar security defects 170. In one embodiment, classifying the new security defect 110B comprises evaluating an invalid defects rate as a threshold parameter 150. When the threshold parameter is exceeded, the computer system 100 classifies the new security defect 110B using an ensemble model 180. The ensemble model 180 may comprise the model invalidity prediction and one or more additional classifiers, including lazy learners, probabilistic models, or some combination thereof. In some embodiments, the one or more additional classifiers may be trained using data from the database 160 as a training dataset, such as data associated with the historical security defects 110A (e.g., embedding vectors 120A and model invalidity predictions), or a subset thereof. For example, the embedding vectors 120A of similar security defects 170 to the new security defect 110B may be used to train a lazy learner and a probabilistic model when ensemble learning is triggered, where the model invalidity predictions of the similar security defects 170 may be used as labels during supervised training. The one or more additional classifiers produce classifications that are compared to the model invalidity prediction to determine a valid or invalid classification 190. For example, the ensemble model 180 may determine the valid or invalid classification 190 by simple majority voting.

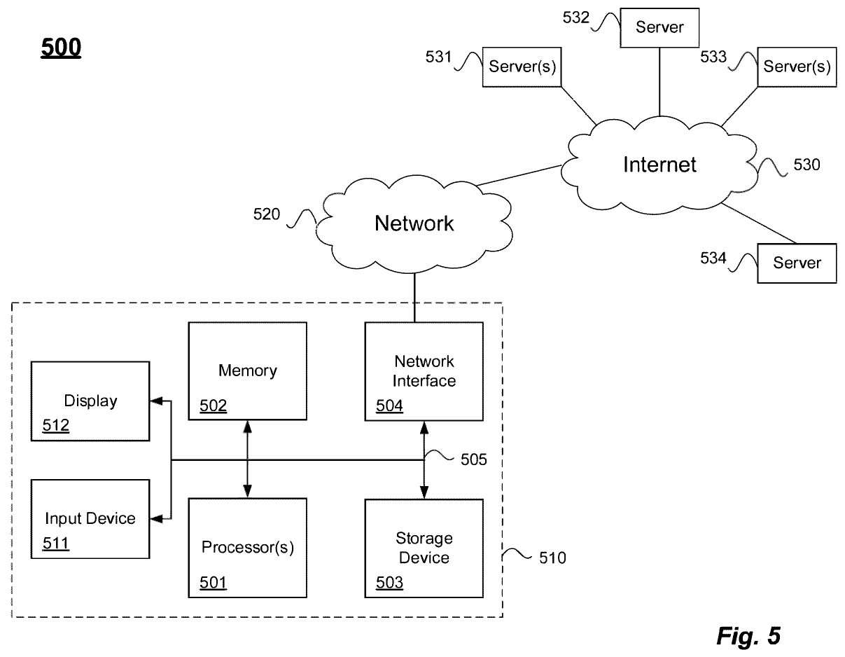

FIG. 3A illustrates a system for training an AI for predicting invalid security defects according to an embodiment. The computer system 300 is configured to generate a trained large language embedding model 120 using a first training dataset 310A and a second training dataset. In embodiments, the computer system 300 may be the same or similar computer system as computer system 100 of FIG. 1 and computing system 500 of FIG. 5. As such, in various embodiments, computer system 100, computer system 300, and computing system 500 may share some or all of the same features. The computer system 300 is configured to train the large language model by learning embedding representations of security defect data, and thus capture the semantic meaning of the security defects in a high-dimensional space. Embedding representations may comprise embedding matrices. Each row in an embedding matrix may relate to unique descriptions of defects found in security defect logs, and each column may relate to a unique feature dimension of the embedding representation. For example, the value of each cell in the embedding matrix may represent how a feature or latent relationship between the security defects is parameterized or weighted when performing tasks. When a security defect is applied to the trained large language embedding model 120, its embedding vector can be generated by performing a lookup against the learned embedding representations. For example, the attributes and descriptions of a security defect may be tokenized and indexed to particular rows of an embedding matrix.

In embodiments, to form the trained large language embedding model 120 through training, the combination of a first representation 310D and a second representation 320D of the security defects is learned. To obtain the first representation 310D, the computer system 300 uses a first training dataset 310A to train a first embedding model 310. The first training dataset 310A may comprise a set of security defect logs expressed as natural language, which may comprise natural language descriptions of security effect attributes. For example, the headers, events, and other attributes of security defects can be parsed and written into input sentences.

FIG. 3C illustrates an example of a security defect log expressed as natural language in the first training dataset 310A according to an embodiment. The security defect log may comprise a set of attributes, including a category, a function, a file, extra information, an effect, a detailed description, a file path name, an event description, an event tag, an event kind, and an importance. To configure the security defect into a natural language format that can be understood by a language model, preprocessing may be required, including data cleaning, word segmentation, and parts of speech tagging. The attributes may be originally expressed in the security defect log as a list of fields and values within a data message. For example, the data message may be a JSON file containing name-value pairs corresponding to each attribute of a security defect. To express the attributes as natural language, the data message may be parsed and written into plaintext sentences relating to what each attribute signifies, which can then be preprocessed through tokenization, word segmentation, and/or parts-of-speech (POS) tagging. For example, the category attribute can be expressed as defect description 300C-1, written as the plaintext sentences, “The software defect has been found by Coverity tool checker {checker}. This defect is categorized as a {displayCategory},” where the function expressed in brackets extracts the relevant field or value from the security defect log and inserts it into the sentence. Defect description 300C-2, relating to the function, file, and extra information attributes can be expressed as the plaintext sentences, “The software defect occurs in function {displayFunction} of file {displayFile} of component {displayComponent}. The additional information from the Coverity tool is {mergeExtra}.” Defect description 300C-3, relating to the effect and detailed description attributes can be expressed as, “The software defect can affect {localEffect}, the detail description of the defect is {longDescription}.” Defect description 300C-4, relating to the file path name, event description, event tag, and event kind attributes can be expressed as, “The event occurs in file path name {filePathname}, the event description is {eventDescription}, the event tag is {eventTag}, and the event kind is {eventKind}.” Defect description 300C-5, relating to the importance attribute can be expressed as, “The important event occurs in file path name {filePathname}, the event description is {eventDescription}, the event tag is {eventTag}, and the event kind is {eventKind}.” In embodiments, each defect description in the first training dataset 310A, such as defect description 300C-1 through 300C-5 may be passed through the first embedding model 310 as an input sentence to generate an embedding and build the first representation 310D. The embedding of each defect description may be indexed to a row in an embedding matrix having a predefined number of feature dimensions. In some embodiments, tens of thousands of defect descriptions may be used in the first training dataset 310A and represented across hundreds of feature dimensions.

Returning to FIG. 3A and the description of the first embedding model 310, the first embedding model 310 is configured to learn local and global representations of the first training dataset 310A. In one embodiment, the first embedding model 310 comprises a transformer 310B and a recurrent neural network (RNN). For example, the recurrent neural network may be a long short-term memory (LSTM), gated recurrent unit (GRU), or simple RNN. The transformer 310B is used to learn a global representation of the first training dataset 310A, and the recurrent neural network is used to learn a local representation of the first training dataset 310A. For example, the embeddings of a local representation may capture sequential dependencies within the first training dataset 310A, such as the relations between attributes, events, and descriptions appearing closely in time or in sequence within an input sentence. Meanwhile the embeddings of the global representation may capture the larger context of how each token appears within the first training dataset 310A, regardless of its position within an input sentence. Each recurrent cell in an RNN processes inputs sequentially and maintains a hidden state. During training, the RNN can learn the embedding vector of each input sentence by extracting the final hidden state of each input. To build a local representation of the security defects, the embedding vectors can be indexed to rows in a matrix.

The transformer 310B comprises an attention mechanism 311B, a feed forward network 313B, and a set of stabilization blocks 312B. During training, the attention mechanism 311B learns the dependencies between tokens of an input sentence and comprises a plurality of attention blocks, which may be self-attention blocks. For example, the attention mechanism 311B may comprise multi-head attention. The feedforward network refines the learned dependencies from the attention mechanism 311B. In one embodiment, the feed forward network 313B may comprise a multilayer perceptron (MLP). The output from the attention mechanism 311B is fed to the feed forward network 313B through the stabilization blocks 312B, which stabilize the training process by providing residual (skip) connections between layers and providing layer normalizations across the feature dimensions. After passing through the feed forward network 313B, the learned dependencies are passed through stabilization blocks 312B again before outputting the embedding vector of the input sentence. The RNN and the transformer 310B each build a representation of the first training dataset 310A during training, each contributing to the output of the first embedding model 310. In embodiments, the local representation matrix learned by the RNN and the global representation matrix learned by the transformer 310B are combined using a matrix operation 310D to form the first representation 310D of the security defects. For example, if the global representation matrix and local representation matrix are configured to have the same dimensions, they may be summed element by element to form the output of the first embedding model 310.

To obtain the second representation 320D of the security defects, the computer system 300 uses a second training dataset 320A to train a second embedding model. In embodiments, the second training dataset 320A comprises prompts for instructing a large language model to predict whether a security defect is valid or invalid based on its attributes. FIG. 3D illustrates an example of a prompt 300D in the second training dataset 320A according to an embodiment. The example prompt 300D includes a plaintext instruction 300D-1 for the large language model to determine if a security issue is a false positive. In the example prompt 300D, the large language model is given labeling criteria 300D-2. In this example, the labeling criteria is 0 for true positive (actual defect), i.e., valid, and 1 for false positive (incorrect alert), i.e., invalid. The example prompt 300D further includes a security log summary 300D-3 that lists the event chain/sequence, category, type, impact, file path name/location, and other defect attributes, including the attribute values for attribute 300D-4—the defect identifier: 273561, attribute 300D-5—checker status: uncaught exception, attribute 300D-6—the defect category: error handling, attribute 300D-7—the defect impact: medium, and in the event chain 300D-8, attribute 300D-9—type: uncaught exception, attribute 300D-10—description: C++ exception causes program termination, and attribute 300D-11—location: /srs/abc/***. cpp. In addition to the prompt itself, each prompt in the second training dataset 320A may be associated with a label 300D-12 indicating whether the underlying security defect is valid or invalid.

Returning to FIG. 3A, the computer system 300 uses the prompt and its label for supervised fine-tuning. In one embodiment, the supervised fine-tuning may comprise parameter-efficient fine-tuning, such as low-rank adaptation (LoRA). For supervised fine-tuning, the computer system 300 obtains a pre-trained large language model that has been trained on a large corpus of general text. The parameter matrix of the pre-trained large language model 321B represents broad linguistic patterns that are not specific to the security defect domain. To fine-tune the model 321B, the prompts are applied to the model 321B and the output of the model are compared to its associated label in a supervised classification task. As the large language model 321B updates its parameter matrix during finetuning, embeddings 320C are extracted from the last hidden states of the prompt. For example, an embedding vector can be pulled from the final hidden state of a classify (CLS) token corresponding to the aggregate representation of the prompt during the classification task. The CLS token can be configured as the first token of the prompt, while in other embodiments the final embedding vector can be extracted from the last token of the prompt or by taking an average of all embedding vectors in the prompt while in its final hidden state. After supervised finetuning, the computer system 300 can index the embedding vectors to rows of an embedding matrix to form the second representation 320D of the security defects as the output of the second embedding model.

Representation fusion 330 learns a combination of the first representation 310D and second representation 320D to form the trained large language embedding model 120. To learn the combination of representations, representation fusion 330 may perform matrix operations on first representation 310D and the second representation 320D. In one embodiment, the matrix operations may comprise merging the embedding matrices 330A of the first representation 310D and the second representation 320D to form the trained large language embedding model 120. For example, the embedding matrices 330A may be concatenated to generate an enlarged embedding matrix that forms the embedding matrix of the trained large language model. In one embodiment, representation fusion 330 further learns the combination of representations by performing attention on the first representation 310D and the second representation 320D. For example, representation fusion 330 can determine a relative importance or “attention score” of each token in the first representation 310D and second representation 320D and apply the attention scores as additional contributions or “soft weights” to the embedding matrix of the trained large language model. In embodiments, the trained large language embedding model 120 is configured to pass embedding vectors compiled from its embedding matrix through the one or more neural networks (e.g., activation layer) to predict the “valid” or “invalid” classifications of security defects.

FIG. 3B illustrates a computer-implemented method for training an AI for predicting invalid security defects according to an embodiment. At 301, computer system 300 receives a first training dataset 310A comprising natural language descriptions of security defect attributes. At 302, the computer system 300 trains a first embedding model 310 using the first training dataset 310A to learn a first representation 310D of the security defects. In one embodiment, the first embedding model 310 comprises a transformer 310B for learning a global representation and a recurrent neural network 310C (e.g., LSTM) for learning a local representation of the security defects, and the trained first embedding model 310 combines the global representation and the local representation. At 303, computer system 300 receives a second training dataset 320A comprising prompts for instructing a large language model to predict whether a security defect is valid or invalid based on its attributes. At 304, the computer system 300 trains the second embedding model using the second training dataset 320A to learn a second representation 320D of the security defects. In one embodiment, the second embedding model is trained by fine-tuning a pretrained large language model and extracting embedding vectors from the last hidden state during fine tuning. At 305, the computer system 300 learns a combination of the first and second representation 320D of the security defects to form a trained large language embedding model 120. In one embodiment, the combination can be learned by merging the embedding matrices 330A of the first and second representation 320D to form an enlarged embedding matrix.

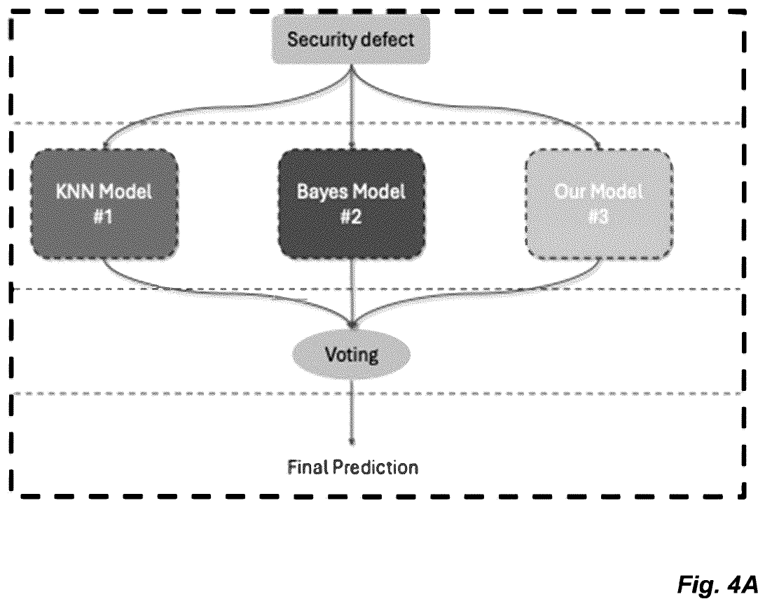

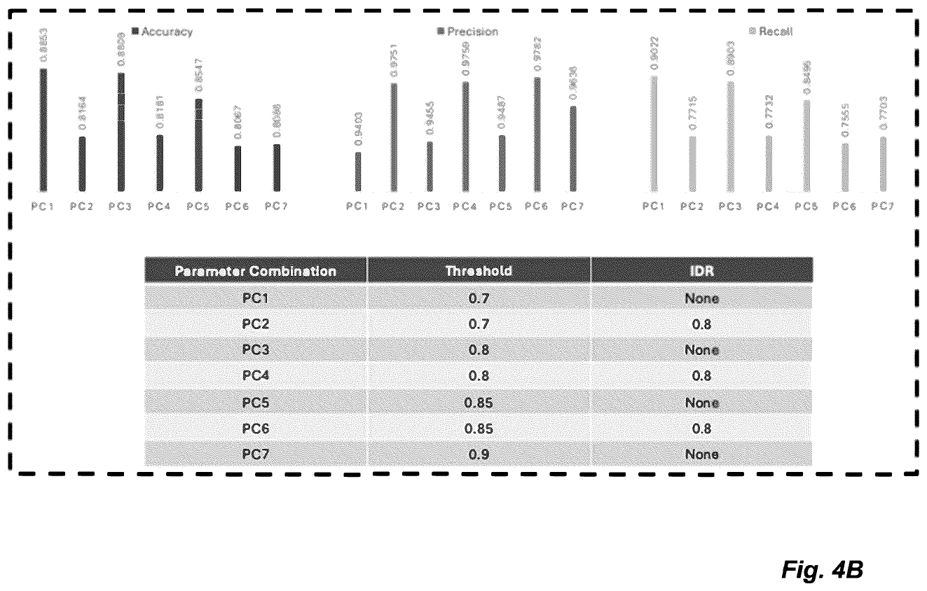

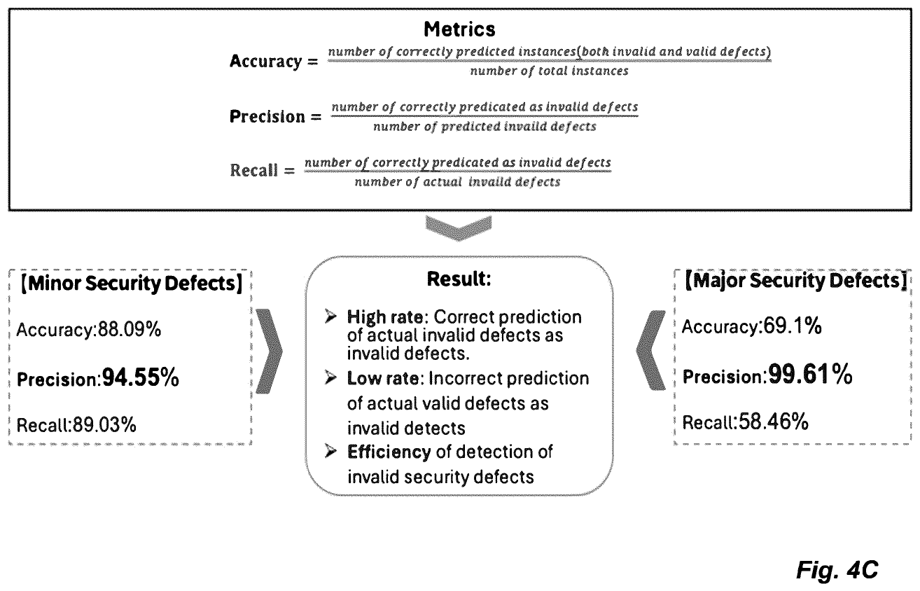

FIG. 4A illustrates an ensemble model according to an embodiment. In the example ensemble model, three classifiers are used, including a KNN model, Bayes Model, and the trained large language embedding model 120. Each classifier predicts the classification of the security defect, and its prediction is cast as a single vote. The majority vote (e.g., at least two votes for invalid against one or fewer votes for valid) determines the final prediction.

FIG. 4B illustrates examples of threshold parameters according to an embodiment. In the example, the threshold parameter 150 is configured as a combination of two parameters—a similarity threshold and an invalid defects rate (IDR). The similarity threshold parameters tested were 0.7 similarity to 0.9 similarity on the [−1 to 1] scale. The IDR rate parameters tested were combinations of 0.8 and “none,” referring to no IDR threshold and reevaluating every model invalidity prediction using ensemble learning. The parameter combinations PC1, PC2, PC3,PC4, PC5, PC6, and PC7 were evaluated for performance, including accuracy, precision, and recall. Accuracy may be calculated as the number of correctly predicted instances of valid and invalid security defects over the number of total instances. Precision may be calculated as the number of correctly predicted invalid security defects over the total number of security defects predicted as invalid. Recall may be calculated as the number of correctly predicted invalid security defects over the actual total number of invalid security defects. From the evaluation shown in FIG. 4B, the AI configured without an IDR threshold achieved up to 90% recall and 89% accuracy on the test dataset, with increasing accuracy and recall as the similarity threshold was lowered. Meanwhile, by including the IDR component to the threshold, precision increased up to 98%. In embodiments, the threshold parameters can be adjusted to achieve greater accuracy, recall, or precision based on needs. In this particular example, precision could be prioritized by including the IDR component and limiting the number of valid security defects mistakenly labeled as invalid. Alternatively, in this example, the IDR component could be turned off to filter out a greater number of invalid security defects. In one embodiment, the AI performance may be evaluated periodically by computer system 100, and the computer system 100 may be configured to dynamically adjust the threshold parameters. For example, the computer system can be configured to measure accuracy, precision, and/or recall for different sets of threshold parameters and determine a threshold adjustment that may be optimal or that improves performance in at least one of these metrics.

FIG. 4C illustrates an example of measured performance according to an embodiment. The example may be representative of an AI trained on a dataset of over 10,000 security defects, the majority of which (e.g., 60%-80%) may be labeled as invalid and minority being valid. For example, in embodiments, security defects obtained by the computer system may be used to train and evaluate the AI (e.g., 60% used as training data and 40% used to test, evaluate, and/or re-evaluate the model's performance). In the example shown in FIG. 4C, the performance of the AI is divided between the performance as measured against minor security defects and against major security defects. As desired, the AI achieves over 88% accuracy and 89% recall, and is therefore able to detect/filter many invalid security defects from amongst the minor security defects. Additionally, as desired, the AI achieves over 99% precision with respect to major security defects, meaning little to no valid security defects are misclassified as invalid. In certain instances, accuracy and recall may not be prioritized over precision for major security defects because a misclassification of a valid major security defect as invalid may be significantly undesirable.

FIG. 5 illustrates hardware of a special purpose computing system 500 configured according to the above disclosure. The following hardware description is merely one example. It is to be understood that a variety of computers topologies may be used to implement the above-described techniques. An example computer system 510 is illustrated in FIG. 5. Computer system 510 includes a bus 505 or other communication mechanism for communicating information, and one or more processor(s) 501 coupled with bus 505 for processing information. Computer system 510 also includes memory 502 coupled to bus 505 for storing information and instructions to be executed by processor 501, including information and instructions for performing some of the techniques described above, for example. Memory 502 may also be used for storing programs executed by processor(s) 501. Possible implementations of memory 502 may be, but are not limited to, random access memory (RAM), read only memory (ROM), or both. A storage device 503 is also provided for storing information and instructions. Common forms of storage devices include, for example, a hard drive, a magnetic disk, an optical disk, a CD-ROM, a DVD, solid state disk, a flash or other non-volatile memory, a USB memory card, or any other electronic storage medium from which a computer can read. Storage device 503 may include source code, binary code, or software files for performing the techniques above, for example. Storage device 503 and memory 502 are both examples of non-transitory computer readable storage mediums (aka, storage media).

In some systems, computer system 510 may be coupled via bus 505 to a display 512 for displaying information to a computer user. An input device 511 such as a keyboard, touchscreen, and/or mouse is coupled to bus 505 for communicating information and command selections from the user to processor 501. The combination of these components allows the user to communicate with the system. In some systems, bus 505 represents multiple specialized buses for coupling various components of the computer together, for example.

Computer system 510 also includes a network interface 504 coupled with bus 505. Network interface 504 may provide two-way data communication between computer system 510 and a local network 520. Network 520 may represent one or multiple networking technologies, such as Ethernet, local wireless networks (e.g., WiFi), or cellular networks, for example. The network interface 504 may be a wireless or wired connection, for example. Computer system 510 can send and receive information through the network interface 504 across a wired or wireless local area network, an Intranet, or a cellular network to the Internet 530, for example. In some embodiments, a frontend (e.g., a browser), for example, may access data and features on backend software systems that may reside on multiple different hardware servers on-prem 531 or across the network 530 (e.g., an Extranet or the Internet) on servers 532-534. One or more of servers 532-534 may also reside in a cloud computing environment, for example.

### Further Examples

Each of the following non-limiting features in the following examples may stand on its own or may be combined in various permutations or combinations with one or more of the other features in the examples below. In various embodiments, the present disclosure may be implemented as a system, method, or computer readable medium.

Embodiments of the present disclosure may include systems, methods, or computer readable media. In one embodiment, the present disclosure includes computer system comprising: at least one processor and at least one non-transitory computer readable medium (e.g., memory) storing computer executable instructions that, when executed by the at least one processor, cause the computer system to perform methods as described herein and in the following examples. In another embodiment, the present disclosure includes a non-transitory computer-readable medium storing computer-executable instructions that, when executed by at least one processor, perform the methods as described herein and in the following examples.

In one embodiment, the present disclosure includes a computer implemented method comprising: receiving historical security defects; applying the historical security defects to a trained large language embedding model to generate embedding vectors and model invalidity predictions for the historical security defects, wherein each model invalidity prediction is generated by passing a corresponding embedding vector through one or more neural network layers; storing the embedding vectors and the model invalidity predictions for the historical security defects in a database; receiving a new security defect; applying the new security defect to the trained large language embedding model to generate an embedding vector and a model invalidity prediction for the new security defect; using the embedding vector of the new security defect to search for similar security defects in the database; and classifying the new security defect as valid or invalid based at least in part on the model invalidity prediction of the new security defect and the similar security defects.

In one embodiment, the embedding model is trained by: receiving a first training dataset comprising natural language descriptions of security defect attributes; training a first embedding model using the first training dataset to learn a first representation of the security defects; receiving a second training dataset comprising prompts for instructing a large language model to predict whether a security defect is valid or invalid based on its attributes; training a second embedding model using the second training dataset to learn a second representation of the security defects; and learning a combination of the first and second representations of the security defects to form the trained large language embedding model.

In one embodiment, the first embedding model comprises a transformer and a recurrent neural network, and training the first embedding model comprises: learning a global representation matrix using the transformer; learning a local representation matrix using the recurrent neural network; and combining the global representation matrix and the local representation matrix to form the first representation of the security defect.

In one embodiment, the second training dataset comprises valid defect labels and invalid defect labels associated with the prompts, and training the second embedding model comprises: obtaining a pre-trained large language model; supervised finetuning the pre-trained large language model using the prompts and the associated valid defect labels and invalid defect labels; extracting embeddings from a last hidden state of the prompts to form the second representation.

In one embodiment, learning the combination of the first representation and the second representation comprises merging embedding matrices of the first representation and the second representation to form the trained large language embedding model.

In one embodiment, classifying the new security defect as valid or invalid based at least in part on the model invalidity prediction of the new security defect and the similar security defects comprises: evaluating the similar security defects against a threshold parameter; and if the threshold parameter is exceeded, applying the model invalidity prediction of the new security defect and the similar security defects to an ensemble model to generate an invalidity classification.

In one embodiment, applying the model invalidity prediction of the new security defect and the similar security defects to the ensemble model comprises: generating a first classification of the new security defect using a lazy learner algorithm trained on the similar security defects; generating a second classification of the new security defect using a probabilistic model trained on the similar security defects; and comparing the first classification and the second classification to the model invalidity prediction of the new security defect to determine the invalidity classification generated by the ensemble model.

In one embodiment, the threshold parameter comprises at least one of: a vector similarity threshold or a threshold rate of invalid defects.

In one embodiment, evaluating the similar security defects against the threshold parameter comprises obtaining the similar security defects having a vector similarity score that exceeds the vector similarity threshold; calculating a rate of invalid defects based on the model invalidity predictions of the similar security defects; and determining if the rate of invalid defects exceeds the threshold rate of invalid defects.

The above description illustrates various embodiments along with examples of how aspects of some embodiments may be implemented. The above examples and embodiments should not be deemed to be the only embodiments and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A computer implemented method comprising:
receiving historical security defects;
applying the historical security defects to a trained large language embedding model to generate embedding vectors and model invalidity predictions for the historical security defects, wherein each model invalidity prediction is generated by passing a corresponding embedding vector through one or more neural network layers;
storing the embedding vectors and the model invalidity predictions for the historical security defects in a database;
receiving a new security defect;
applying the new security defect to the trained large language embedding model to generate an embedding vector and a model invalidity prediction for the new security defect;
using the embedding vector of the new security defect to search for similar security defects in the database; and
classifying the new security defect as valid or invalid based at least in part on the model invalidity prediction of the new security defect and the similar security defects.

2. The method of claim 1, wherein the trained large language embedding model is trained by:
receiving a first training dataset comprising natural language descriptions of security defect attributes;
training a first embedding model using the first training dataset to learn a first representation of the security defects;
receiving a second training dataset comprising prompts for instructing a large language model to predict whether a security defect is valid or invalid based on its attributes;
training a second embedding model using the second training dataset to learn a second representation of the security defects; and
learning a combination of the first and second representations of the security defects to form the trained large language embedding model.

3. The method of claim 2, wherein the first embedding model comprises a transformer and a recurrent neural network, and wherein training the first embedding model comprises:
learning a global representation matrix using the transformer;
learning a local representation matrix using the recurrent neural network; and
combining the global representation matrix and the local representation matrix to form the first representation of the security defect.

4. The method of claim 2, wherein the second training dataset comprises valid defect labels and invalid defect labels associated with the prompts, and wherein training the second embedding model comprises:
obtaining a pre-trained large language model;
supervised finetuning the pre-trained large language model using the prompts and the associated valid defect labels and invalid defect labels; and
extracting embeddings from a last hidden state of the prompts to form the second representation.

5. The method of claim 2, wherein learning the combination of the first representation and the second representation comprises merging embedding matrices of the first representation and the second representation to form the trained large language embedding model.

6. The method of claim 1, wherein classifying the new security defect as valid or invalid based at least in part on the model invalidity prediction of the new security defect and the similar security defects comprises:
evaluating the similar security defects against a threshold parameter; and
if the threshold parameter is exceeded, applying the model invalidity prediction of the new security defect and the similar security defects to an ensemble model to generate an invalidity classification.

7. The method of claim 6, wherein applying the model invalidity prediction of the new security defect and the similar security defects to the ensemble model comprises:
generating a first classification of the new security defect using a lazy learner algorithm trained on the similar security defects;
generating a second classification of the new security defect using a probabilistic model trained on the similar security defects; and
comparing the first classification and the second classification to the model invalidity prediction of the new security defect to determine the invalidity classification generated by the ensemble model.

8. The method of claim 6, wherein the threshold parameter comprises at least one of:
a vector similarity threshold; or
a threshold rate of invalid defects.

9. The method of claim 8, wherein evaluating the similar security defects against the threshold parameter comprises:
obtaining the similar security defects having a vector similarity score that exceeds the vector similarity threshold;
calculating a rate of invalid defects based on the model invalidity predictions of the similar security defects; and
determining if the rate of invalid defects exceeds the threshold rate of invalid defects.

2. A computer system comprising:
at least one processor;
at least one non-transitory computer-readable medium storing computer-executable instructions that, when executed by the at least one processor, cause the computer system to execute a method comprising:
receiving historical security defects;
applying the historical security defects to a trained large language embedding model to generate embedding vectors and model invalidity predictions for the historical security defects, wherein each model invalidity prediction is generated by passing a corresponding embedding vector through one or more neural network layers;
storing the embedding vectors and the model invalidity predictions for the historical security defects in a database;
receiving a new security defect;
applying the new security defect to the trained large language embedding model to generate an embedding vector and a model invalidity prediction for the new security defect;
using the embedding vector of the new security defect to search for similar security defects in the database; and
classifying the new security defect as valid or invalid based at least in part on the model invalidity prediction of the new security defect and the similar security defects.

11. The computer system of claim 10, wherein the trained large language embedding model is trained by:
receiving a first training dataset comprising natural language descriptions of security defect attributes;
training a first embedding model using the first training dataset to learn a first representation of the security defects;
receiving a second training dataset comprising prompts for instructing a large language model to predict whether a security defect is valid or invalid based on its attributes;
training a second embedding model using the second training dataset to learn a second representation of the security defects; and
learning a combination of the first and second representations of the security defects to form the trained large language embedding model.

12. The computer system of claim 11, wherein the first embedding model comprises a transformer and a recurrent neural network, and wherein training the first embedding model comprises:
learning a global representation matrix using the transformer;
learning a local representation matrix using the recurrent neural network; and
combining the global representation matrix and the local representation matrix to form the first representation of the security defect.

13. The computer system of claim 11, wherein the second training dataset comprises valid defect labels and invalid defect labels associated with the prompts, and wherein training the second embedding model comprises:
obtaining a pre-trained large language model;
supervised finetuning the pre-trained large language model using the prompts and the associated valid defect labels and invalid defect labels; and
extracting embeddings from a last hidden state of the prompts to form the second representation.

14. The computer system of claim 11, wherein learning the combination of the first representation and the second representation comprises merging embedding matrices of the first representation and the second representation to form the trained large language embedding model.

15. The computer system of claim 10, wherein classifying the new security defect as valid or invalid based at least in part on the model invalidity prediction of the new security defect and the similar security defects comprises:
evaluating the similar security defects against a threshold parameter; and
if the threshold parameter is exceeded, applying the model invalidity prediction of the new security defect and the similar security defects to an ensemble model to generate an invalidity classification.

16. The computer system of claim 15, wherein applying the model invalidity prediction of the new security defect and the similar security defects to the ensemble model comprises:
generating a first classification of the new security defect using a lazy learner algorithm trained on the similar security defects;
generating a second classification of the new security defect using a probabilistic model trained on the similar security defects; and
comparing the first classification and the second classification to the model invalidity prediction of the new security defect to determine the invalidity classification generated by the ensemble model.

3. A non-transitory computer-readable medium storing computer-executable instructions that, when executed by at least one processor of a computer system, cause the computer system to execute method comprising:
receiving historical security defects;
applying the historical security defects to a trained large language embedding model to generate embedding vectors and model invalidity predictions for the historical security defects, wherein each model invalidity prediction is generated by passing a corresponding embedding vector through one or more neural network layers;
storing the embedding vectors and the model invalidity predictions for the historical security defects in a database;
receiving a new security defect;
applying the new security defect to the trained large language embedding model to generate an embedding vector and a model invalidity prediction for the new security defect;
using the embedding vector of the new security defect to search for similar security defects in the database; and
classifying the new security defect as valid or invalid based at least in part on the model invalidity prediction of the new security defect and the similar security defects.

18. The non-transitory computer-readable medium of claim 17, wherein the trained large language embedding model is trained by:
receiving a first training dataset comprising natural language descriptions of security defect attributes;
training a first embedding model using the first training dataset to learn a first representation of the security defects;
receiving a second training dataset comprising prompts for instructing a large language model to predict whether a security defect is valid or invalid based on its attributes;
training a second embedding model using the second training dataset to learn a second representation of the security defects; and
learning a combination of the first and second representations of the security defects to form the trained large language embedding model.

19. The non-transitory computer-readable medium of claim 18, wherein the first embedding model comprises a transformer and a recurrent neural network, and wherein training the first embedding model comprises:
learning a global representation matrix using the transformer;
learning a local representation matrix using the recurrent neural network; and
combining the global representation matrix and the local representation matrix to form the first representation of the security defect.

20. The non-transitory computer-readable medium of claim 18, wherein the second training dataset comprises valid defect labels and invalid defect labels associated with the natural language prompts, and wherein training the second embedding model comprises:
obtaining a pre-trained large language model;
supervised finetuning the pre-trained large language model using the natural language prompts and the associated valid defect labels and invalid defect labels; and
extracting embeddings from a last hidden state of the prompts to form the second representation.
